(19) United States
(12) Patent Application Publication
(10) Pub. No.: US 2004/0168008 A1
(43) Pub. Date: Aug. 26, 2004

(54) High speed multiple ported bus interface port state identification system

(75) Inventors: Anthony Joseph Benson, Roseville, CA (US); Thin Nguyen, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/370,326

(22) Filed: Feb. 18, 2003

(51) Int. Cl. G06F 13/36

(52) U.S. Cl. 710/306

(57) ABSTRACT

A monitor for a dual ported bus interface comprises a controller coupled to the dual ported bus interface and a programmable code executable on the controller. The dual ported bus interface has first and second front end ports capable of connecting to host bus adapters, and first and second backplane connectors for coupling to one or more buses on the backplane. The dual ported bus interface also has interconnections for coupling signals from the first and second front end ports through to the backplane buses. The programmable code further comprises a programmable code that monitors term power, a differential sense signal, and connectivity states for the first and second front end ports, and a programmable code that identifies port state based on the monitored term power, a differential sense signal, and connectivity states.

### RELATED APPLICATIONS

The disclosed system and operating method are related to subject matter disclosed in the following co-pending patent applications that are incorporated by reference herein in their entirety: (1) U.S. patent application Ser. No. ______, entitled “High Speed Multiple Port Data Bus Interface Architecture”; (2) U.S. patent application Ser. No. ______, entitled “High Speed Multiple Ported Bus Interface Control”; (3) U.S. patent application Ser. No. ______, entitled “High Speed Multiple Ported Bus Interface Expander Control System”; (4) U.S. patent application Ser. No. ______, entitled “System and Method to Monitor Connections to a Device”; (5) U.S. patent application Ser. No. ______, entitled “High Speed Multiple Ported Bus Interface Reset Control System”; and (6) U.S. patent application Ser. No. ______, entitled “Interface Connector that Enables Detection of Cable Connection.”

### BACKGROUND OF THE INVENTION

A computing system may use an interface to connect to one or more peripheral devices, such as data storage devices, printers, and scanners. The interface typically includes a data communication bus that attaches and allows orderly communication among the devices and the computing system. A system may include one or more communication buses. In many systems a logic chip, known as a bus controller, monitors and manages data transmission between the computing system and the peripheral devices by prioritizing the order and the manner of device control and access to the communication buses. Control rules, also known as communication protocols, are imposed to promote the communication of information between computing systems and peripheral devices. For example, Small Computer System Interface or SCSI (pronounced “scuzzy”) is an interface, widely used in computing systems, such as desktop and mainframe computers, that enables connection of multiple peripheral devices to a computing system.

In a desktop computer SCSI enables peripheral devices, such as scanners, CDs, DVDs, and Zip drives, as well as hard drives to be added to one SCSI cable chain. In network servers SCSI connects multiple hard drives in a fault-tolerant cluster configuration in which failure of one drive can be remedied by replacement from the SCSI bus without loss of data while the system remains operational. A fault-tolerant communication system detects faults, such as power interruption or removal or insertion of peripherals, allowing reset of appropriate system components to retransmit any lost data.

A SCSI communication bus follows the SCSI communication protocol, generally implemented using a 50 conductor flat ribbon or round bundle cable of characteristic impedance of 100 Ohm. SCSI communication bus includes a bus controller on a single expansion board that plugs into the host computing system. The expansion board is called a Bus Controller Card (BCC), SCSI host adapter, or SCSI controller card.

In some embodiments, single SCSI host adapters are available with two controllers that support up to 30 peripherals. SCSI host adapters can connect to an enclosure housing multiple devices. In mid to high-end markets, the enclosure may have multiple controller interface or controller cards forming connection paths from the host adapter to SCSI buses resident in the enclosure. Controller cards can also supply bus isolation, configuration, addressing, bus reset, and fault detection operations for the enclosure.

One or more controller cards may be inserted or removed from the backplane while data communication is in process, a characteristic termed “hot plugging.”

Single-ended and high voltage differential (HVD) SCSI interfaces have known performance trade-offs. Single ended SCSI devices are less expensive to manufacture. Differential SCSI devices communicate over longer cables and are less susceptible to external noise influences. HVD SCSI is more expensive. Differential (HVD) systems use 64 milliamp drivers that draw too much current to enable driving the bus with a single chip. Single ended SCSI uses 48 milliamp drivers, allowing single chip implementations. High cost and low availability of differential SCSI devices has created a market for devices that convert single ended SCSI to differential SCSI so that both device types coexist on the same bus. Differential SCSI in combination with a single ended alternative is inherently incompatible and has reached limits of physical reliability in transfer rates, although flexibility of the SCSI protocol allows much faster communication implementations.

### SUMMARY OF THE INVENTION

In accordance with some embodiments of the illustrative system, a monitor for a dual ported bus interface comprises a controller coupled to the dual ported bus interface and a programmable code executable on the controller. The dual ported bus interface has first and second front end ports capable of connecting to host bus adapters, and first and second backplane connectors for coupling to one or more buses on the backplane. The dual ported bus interface also has interconnections for coupling signals from the first and second front end ports through to the backplane buses. The programmable code further comprises a programmable code that monitors term power, a differential sense signal, and connectivity states for the first and second front end ports, and a programmable code that identifies port state based on the monitored term power, a differential sense signal, and connectivity states.

In accordance with another embodiment, a dual ported bus interface comprises first and second front end ports capable of connecting to host bus adapters, and first and second backplane connectors for coupling to one or more buses on the backplane. The bus interface further comprises interconnections including a bridge connection for coupling signals from the first and second front end ports through to the backplane buses. A monitor monitors term power, a differential sense signal, and connectivity states for the first and second front end ports. A controller that identifies port state based on the monitored term power, a differential sense signal, and connectivity states.

In accordance with a further embodiment, a method of identifying port state for a dual ported bus interface comprises connecting to first and second front end ports of the dual ported bus interface, and monitoring term power, a differential sense signal, and connectivity states for the ports. The method further comprises identifying port state based on the monitored term power, a differential sense signal, and connectivity states.

### BRIEF DESCRIPTION OF THE DRAWINGS

Embodiments of the invention relating to both structure and method of operation, may best be understood by referring to the following description and accompanying drawings.

FIG. 1 is a schematic block diagram that illustrates an embodiment of a bus architecture.

FIG. 2 is a schematic circuit diagram that can be used to determine whether proper connections are made in the bus architecture shown in FIG. 1.

FIG. 3 is a state diagram showing an embodiment of a state machine capable of determining whether a connector is being attached or removed from the circuit shown in FIG. 2.

FIG. 4 is a state diagram that depicts a state machine embodiment capable of determining whether a connector is properly attached to a device.

FIG. 5 is a schematic block diagram showing an example of a communication system with a data path architecture between one or more bus controller cards, peripheral devices, and host computers including, respectively, a system view, component interconnections, and monitor elements.

### DETAILED DESCRIPTION

To address deficiencies and incompatibilities inherent in the physical SCSI interface, Low Voltage Differential SCSI (LVD) has been developed. Twenty-four milliamp LVD drivers can easily be implemented within a single chip, and use the low cost elements of single ended interfaces. LVD can drive the bus reliably over distances comparable to differential SCSI. LVD supports communications at faster data rates, enabling SCSI to continue to increase speed without changing from the LVD physical interface.

A SCSI expander is a device that enables a user to expand SCSI bus capabilities. A user can combine single-ended and differential interfaces using an expander/converter, extend cable lengths to greater distances via an expander/extender, isolate bus segments via an expander/isolator. A user can increase the number of peripherals the system can access, and/or dynamically reconfigure SCSI components. For example, systems based on HVD SCSI can use differential expander/converters to allow a system to access a LVD driver in the manner of a HVD driver.

What is desired in a bus interface that supports high speed signal transmission using LVD drivers is a capability to quickly determine interface state. Port connector status is used to determine interface state enabling SCSI bus resets to be invoked to avoid data corruption and to determine when to enable and disable SCSI bus expanders.

Approximate status of the dual ports of a bus interface can be determined simply on the basis of availability of term power. An improved system more accurately determines dual port status by monitoring term power in combination with differential sense signal (diff_sense) and connectivity states of the individual ports. Improved accuracy is particular desirable for determining connection state of a Hot Swappable High Speed Dual Ported SCSI Bus Interface Controller Card to avoid possible data corruption and system throughput degradation when term power is present but a second port is not terminated.

Port connector status can be used for multiple purposes. Port connector status can be used to determine the state of an interface card. Port connector status can also be used to determine when SCSI bus resets are invoked to avoid data corruption. Port connector status is also useful to determine when to enable or disable SCSI bus expanders.

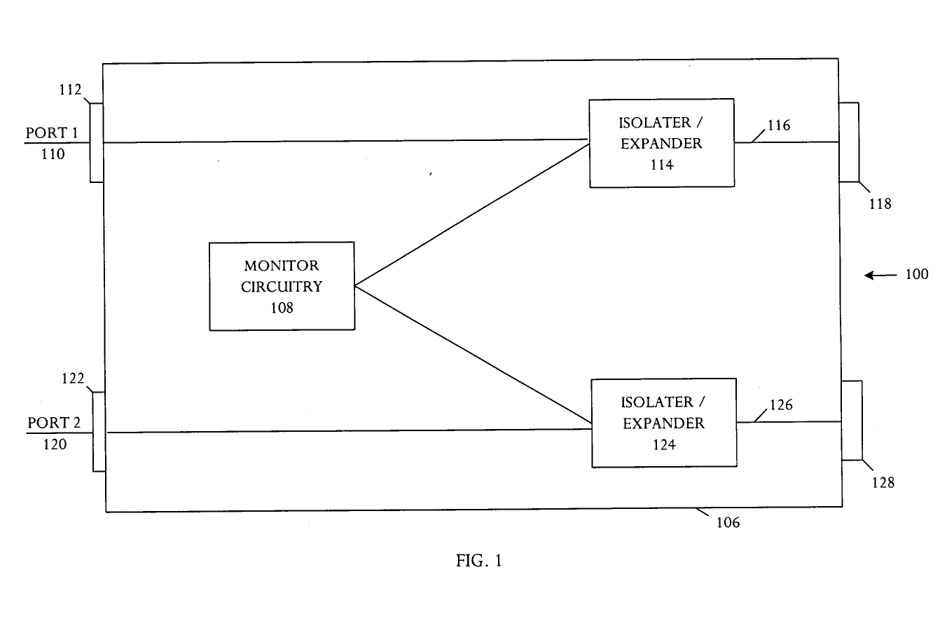

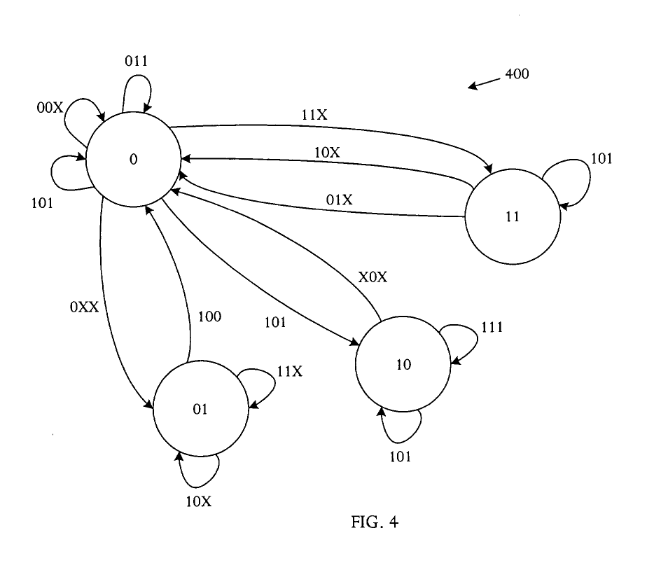

Referring to FIG. 1, a schematic block diagram illustrates an embodiment of a bus architecture 100. In an specific example the bus architecture 100 can be a high speed bus architecture such as a Small Computer Systems Interface (SCSI) bus architecture. In a specific embodiment, the bus architecture 100 can be used in a hot swappable high-speed dual port bus interface card such as a Small Computer Systems Interface (SCSI) bus interface card shown as an enclosure and bus controller card in FIG. 4.

The bus architecture can be configured to include a monitor for monitoring state of the dual ports. Functional elements in the interface, for example electronic hardware and programming elements, perform various monitoring tasks to identify port state. In a particular example, the electronic hardware can comprise various electronic circuit devices such as field programmable gate arrays (FPGAs), programmable logic devices (PLDs), or other control or monitoring devices, and the programming elements can comprise executable firmware code. The monitor accesses various signals to define and identify port state.

In a specific embodiment, the monitor can operate in a dual port bus interface card or bus controller card (BCC). The interface can couple to one or more host computers via a front end and can couple to a backplane of a data bus via a back end. At the back end, terminators can be connected to backplane connectors to signal the terminal end of the data bus. Proper functionality of the terminators depends on supply of sufficient “term power” from the data bus, typically supplied by a host adapter or other devices on the data bus. The dual port system accordingly can include two interfaces or BCCs. Each interface can perform monitoring operations in conjunction with operations of the second interface, called the peer interface or peer card. The dual interfaces can each have a controller that executes instructions to monitor conditions, control the interface, communicate status information and data to host computers via a data bus, such as a SCSI bus; and can also support diagnostic procedures for various components of system. Each interface can also include one or more bus expanders that allow a user to expand the bus capabilities. For example, an expander can mix single-ended and differential interfaces, extend cable lengths, isolate bus segments, increase the number of peripherals the system can access, and/or dynamically reconfigure bus components. The dual port bus interface can be arranged in multiple configurations including, but not limited to, two host computers connected to a single interface in full bus mode, two interfaces in full or split bus mode and two host computers with each interface connected to an associated host computer, and two interfaces in full or split bus mode and four host computers.

The bus architecture 100 comprises two ports 110 and 120 that are connected to respective connectors 112 and 122 and coupled to respective gateway isolator/expanders 114 and 124. The isolator/expanders 114 and 124 perform timer and repeater functions in the signal path. In an illustrative embodiment, connectors 112 and 122 can be Very High Density Cable Interconnect (VHDCI) connectors. The gateway isolator/expanders 114 and 124 coupled to backplane connectors 118 and 128 via stubs 116 and 126 to backplane SCSI buses. Monitor circuitry 108 couples to each gateway isolator/expander 114 and 124.

The bus architecture 100 enables bridging of high speed signals across two separate SCSI buses on the backplane or enables high speed signals from the two VHDCI connectors 112 and 122 to attach to only one of the SCSI buses on the backplane. Without bridging, two interfaces would be needed to attach to each SCSI bus on the backplane, limiting possible configurations.

The bus architecture 100 enables improvement of signal integrity through impedance and length matching, further enabling high speed Low Voltage Differential (LVD) signal flow on a bus interface card 106. In an illustrative embodiment, High Voltage Differential (HVD) or Single-ended SCSI signal flow is not supported.

In a specific embodiment, the SCSI bus connecting the VHDCI connectors 112 and 122, the monitor circuitry 108, and the isolator/expanders 114 and 124 are length and impedance matched across routing layers in a bus interface card 106. Interconnect lines to the VHDCI connectors 112 and 122, monitor circuitry 108, and isolator/expanders 114 and 124 are minimized and can be eliminated by passing signal lines through integrated chip connector pins rather than supplying interconnect traces to the stubs.

SCSI bus stubs 116 and 126 to backplane connectors 118 and 128 can be impedance and length matched. In a specific example, stubs 116 and 126 are reduced to minimum length and configured as point-to-point connections between the backplane connectors 118 and 128 and the isolator/expanders 114 and 124, and stubs are not shared with other devices. To conserve space on an interface 106, interconnect traces can be spread over surface and internal printed circuit board (PCB) layers. Trace widths are varied to match impedance. Trace lengths are varied to match electrical lengths.

In the illustrative embodiment, the isolator/expanders 114 and 124 perform a bridging function so that a dedicated bridge circuit or chip can be omitted. Status of the isolator/expanders 114 and 124 depends on enclosure configuration, position of the isolator/expanders 114 and 124 in the enclosure, and interface card status of the bus interface card 106 and an associated peer card. The bridging function becomes active when two isolator/expanders 114 and 124 on the same bus interface card 106 are enabled.

The SCSI bus architecture 100 supports high-speed signals at least partly through usage of simple control functionality between SCSI bus control interface cards. Control functions manage operability on the basis of card status, isolater/expander status, VHDCI connector status, and enclosure element control status including fan speed, DIP switch configuration, disk LED status, enclosure LED status, and monitor circuitry status.

The illustrative bus architecture 100 enables valid SCSI connection for a dual ported controller card with a low voltage differential (LVD) SCSI data bus. In a specific embodiment SCSI standards specify a term power range between 3.0 volts and 5.25 volts, and a diff_sense signal voltage range between 0.7 volts and 1.9 volts to indicate an LVD connection. The SCSI standards further specify that at least one port is connected to a Host Bus Adapter (HBA) that supplies termination, term power, and diff_sense signal. The other port can be connected to another HBA or a terminator.

The SCSI bus associated with the front end can be in one of four states including Not Connected, Connected, Improperly Connected, or Faulted. The state of the SCSI bus associated with the front end has a direct impact on the interface card state. The possible interface card states include Primary, Pseudo-Primary, Pseudo-Primary Fault, Secondary, Pseudo-Secondary, Pseudo-Secondary Fault, and Fault. Determining the SCSI bus state of the front end is relatively complex. Relationships between front end and interface card states are depicted in TABLE I as follows.

TABLE I

| | | | | Front End SCSI BUS |
|---|---|---|---|---|
| FE_LVD_IND | Term Power | Connector A | Connector B | State |
| Not Available | Not Available | Connected | Connected | Not Connected |
| Not Available | Not Available | Connected | Unconnected | Improperly Connected |
| Not Available | Not Available | Unconnected | Connected | Improperly Connected |
| Not Available | Not Available | Unconnected | Unconnected | Not Connected |
| Not Available | Available | Connected | Connected | Improperly Connected |
| Not Available | Available | Connected | Unconnected | Improperly Connected |
| Not Available | Available | Unconnected | Connected | Improperly Connected |
| Not Available | Available | Unconnected | Unconnected | Fault |
| Available | Not Available | Connected | Connected | Not Connected* |
| Available | Not Available | Connected | Unconnected | Improperly Connected* |
| Available | Not Available | Unconnected | Connected | Improperly Connected* |
| Available | Not Available | Unconnected | Unconnected | Not Connected* |
| Available | Available | Connected | Connected | Connected |
| Available | Available | Connected | Unconnected | Improperly Connected |
| Available | Available | Unconnected | Connected | Improperly Connected |
| Available | Available | Unconnected | Unconnected | Fault |

Asterisks in TABLE I in the description indicate that Front End Bus State is listed as Not Connected or Improperly Connected because the LVD diff_sense signal will float above 0.6 volts, causing a comparator to detect presence of an LVD connection.

The signal can float even when a connection exists on one of the ports. Accordingly if no term power is present, the FE_LVD_IND signal is invalid.

Logic equations associated with the truth table are as follows:

Connected=FE_{—}LVD_{—}IND*ConnectorA*ConnectorB*Term Power

Not Connected=!Term Power(ConnectorA*ConnectorB+!ConnectorA*!Connecector B)

Improperly Connected=ConnectorA*!Connector B+!ConnectorA*ConnectorB+!FE_{—}LVD_{—}IND*TermPower*ConnectorA*ConnectorB

Fault=TermPower*!ConnectorA*!ConnectorB

Fault terms are combined into the interface card that identifies a fault status. When the fault occurs, all other signals are disregarded. The fault equation is expanded to included other faults generated in other sections of the system.

Referring to TABLE II, a binary number associates to the Front End SCSI bus state.

TABLE II

| | Front End SCSI Bus State |
|---|---|
| 00 | Connected |
| 01 | Not Connected |
| 10 | Improperly Connected |
| 11 | Fault |

An approximate status of dual ports can be determined simply on the basis of availability of term power. The illustrative system improves the accuracy for determining dual port status by monitoring term power in combination with differential sense signal (diff_sense) and connectivity states of the individual ports. Improved accuracy is particular desirable for determining connection state of a Hot Swappable High Speed Dual Ported SCSI Bus Interface Controller Card to avoid possible data corruption and system throughput degradation when term power is present but a second port is not terminated.

Port connector status can be used for multiple purposes. Port connector status can be used to determine interface card state. Port connector status can also be used to determine when SCSI bus resets are invoked to avoid data corruption. Port connector status is also useful to determine when to enable or disable SCSI bus expanders.

Connector A and Connector B signals can be derived using a technique for sensing a connection to a port on a dual ported controller, such as a Dual Ported SCSI Controller Card.

Term power and diff_sense signal are common signals that run through both ports A 110 and B 120 as in the SCSI specification (SPI through SP-4). If only one port is connected to an operating Host Bus Adapter (HBA), the term power and diff_sense signals remain although a valid front end connection no longer exists. Accordingly both ports 110 and 120 are monitored by various monitoring circuits, devices, and components to assure both have valid connections.

Some systems may use “auto-termination” circuitry to determine whether the SCSI bus has proper termination based on current sensed in any of multiple SCSI signals. Difficulties with the auto-termination approach result from usage of a variety of components with different electrical behavior and a resulting variation in current. The illustrative technique doe not use current-sensing auto-termination techniques and presumes that a user properly configure the Host Bus Adapter (HBA) with termination.

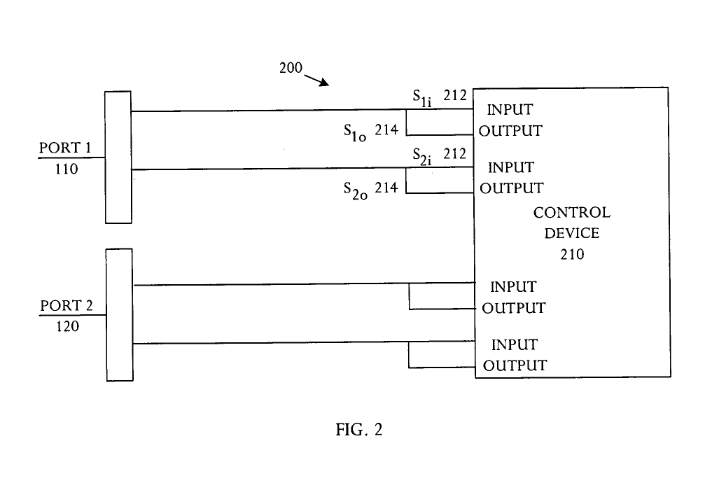

The technique determines whether a proper front end connection exists by having the individual ports 110 and 120 isolate multiple ground pins, pull the ground pins high, and monitor the ground pins to determine whether the pins are pulled low due to a connection. At least two pins are isolated to avoid a condition in which an HBA also has one ground pin isolated for the same reason. The technique utilizes the circuit diagrammed in FIG. 2 to manage the manner in which a pin that is not pulled down due to the pin's condition as isolated and pulled up on the other end.

The individual signals connected to an isolated ground pin on a port is connected to two ports of a control device 210, such as a Field Programmable Gate Array (FPGA) or Programmable Logic Device (PLD). One control device monitoring port, for example S₁ᵢ or S₂ᵢ, is configured as an input port, and a second port, for example S₁ₒ or S₂ₒ, is set as an output port and tri-stated (disabled) when not pulling the signal low. At least two isolated ground pins are allocated per connector port. If one signal is pulled low as a result of a connection, that signal alerts the control device 210 to pull the second line down so that the other device will also sense the connection. Logic executing on the control device 210 transfers to another state and waits for at least one signal to go high, indicating a disconnection. Upon disconnection, all output signals S₁ₒ and S₂ₒ are tri-stated.

Referring to TABLE III, a truth table shows state relationships for two input signals and two output signals with state signals associated with the output signals.

TABLE III

| | Input S2 (I2) | Input S1 (I1) | State 1 | State 0 |
|---|---|---|---|---|
| 0 | 0 | 0 | 0 | 0 |
| 1 | 0 | 0 | 0 | 1 |
| 2 | 0 | 0 | 1 | 0 |
| 3 | 0 | 0 | 1 | 1 |
| 4 | 0 | 1 | 0 | 0 |
| 5 | 0 | 1 | 0 | 1 |
| 6 | 0 | 1 | 1 | 0 |
| 7 | 0 | 1 | 1 | 1 |
| 8 | 1 | 0 | 0 | 0 |
| 9 | 1 | 0 | 0 | 1 |
| 10 | 1 | 0 | 1 | 0 |
| 11 | 1 | 0 | 1 | 1 |
| 12 | 1 | 1 | 0 | 0 |
| 13 | 1 | 1 | 0 | 1 |
| 14 | 1 | 1 | 1 | 0 |
| 15 | 1 | 1 | 1 | 1 |

Valid states are indicated in bold.

The occurrence of a connection at signal S₁ᵢ causes control device 210 to transition signals S₁ᵢ, S₂ᵢ, S₂ₒ, S₁ₒ through states 0-4-6-14 as shown in Table IV.

TABLE IV

| Path | Input S₂ᵢ | Input S₁ᵢ | State of Output S₂ₒ | State of Output S₁ₒ |
|---|---|---|---|---|
| 0 | 0 | 0 | 0 | 0 |
| 4 | 0 | 1 | 0 | 0 |
| 6 | 0 | 1 | 1 | 0 |
| 14 | 1 | 1 | 1 | 0 |

When a disconnection occurs at signal S₁ᵢ, the state of signals S₁ᵢ, S₂ᵢ, S₂ₒ, S₁ₒ transition through paths 14-10-8-0 as shown in Table V.

TABLE V

| Path | Input S₂ᵢ | Input S₁ᵢ | State of Output S₂ₒ | State of Output S₁ₒ |
|---|---|---|---|---|
| 14 | 1 | 1 | 1 | 0 |
| 10 | 1 | 0 | 1 | 0 |
| 8 | 1 | 0 | 0 | 0 |
| 0 | 0 | 0 | 0 | 0 |

When a connection is sensed at Input S2, the state transition of signals S₁ᵢ, S₂ᵢ, S₂ₒ, S₁ₒ includes paths 0-8-9-13 as shown in Table VI.

TABLE VI

| Path | Input S₂ᵢ | Input S₁ᵢ | State of Output S₂ₒ | State of Output S₁ₒ |
|---|---|---|---|---|
| 0 | 0 | 0 | 0 | 0 |
| 8 | 1 | 0 | 0 | 0 |
| 9 | 1 | 0 | 0 | 1 |
| 13 | 1 | 1 | 0 | 1 |

Signals S₁ᵢ, S₂ᵢ, S₂ₒ, S₁ₒ transition through paths 13-5-4-0, as shown in Table disconnection occurs at input port S2.

TABLE VII

| Path | Input S₂ᵢ | Input S₁ᵢ | State of Output S₂ₒ | State of Output S₁ₒ |
|---|---|---|---|---|
| 13 | 1 | 1 | 0 | 1 |
| 5 | 0 | 1 | 0 | 1 |
| 4 | 0 | 1 | 0 | 0 |
| 0 | 0 | 0 | 0 | 0 |

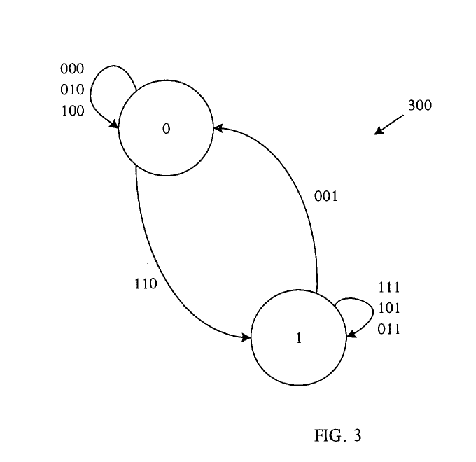

Information regarding whether a connection or disconnection is occurring is used to determine the next state. State information follows from the fact that when a disconnection occurs at signal S₁ᵢ, or a connection occurs at signal S₂ᵢ, the states of signals S₁ᵢ, S₂ᵢ, S₁ₒ, S₂ₒ transition through path 8 (1000). Path 4 (0100) is another common path that is transitioned during a disconnection at signal S₁ₒ, and a connection at port S₂ₒ. State machines 300 and 400 shown in FIGS. 3 and 4, respectively, can be used to determine the next transition state. Then state information, in turn, can be used to determine: (1) whether a connector is being attached to or removed from circuit 200 shown in FIG. 2, (2) the next state based on the values of S₁ᵢ, S₂ᵢ, and (3) whether a connection is being made or broken.

The embodiment of state machine 300 shown in FIG. 3 includes a disconnected state 0 and a connected state 1. The circles and arrows describe how state machine 300 moves from one state to another. In general, the circles in a state machine represent a particular value of the state variable. The lines with arrows describe how the state machine transitions from one state to the next state. One or more boolean expressions are associated with each transition line to show the criteria for a transition from one state to another. If the boolean expression is TRUE and the current state is the state at the source of the arrowed line, the state machine will transition to the destination state on the next clock cycle. The diagram also shows one or more sets of the values of the output variables during each state next to the circle representing the state.

In state machine 300, the input signals S₁ᵢ, S₂ᵢ, and connection status is indicated by a Boolean expression with three numbers representing in order from left to right, the state of the input signals S₂ᵢ and S₁ᵢ, and connection status, where each number can have the value of 1 or 0 depending on the corresponding state of the parameter. For example, States 000, 010 and 100 indicate no connection to a device. A transition from disconnected to connected occurs when State 110 is detected. Similarly, States 011, 101, and 111 indicate a connection to a device, and a transition from connected to disconnected occurs when State 001 is detected.

State machine 400 determines the state of signals S₁ᵢ, S₂ᵢ, S₁ₒ, and S₂ₒ based on connection status and a change in either input signal S₁ᵢ or S₂ᵢ. In some embodiments, the transitions between states follow the paths shown in Tables IV, V, VI, and VII. Input signals S₁ᵢ, S₂ᵢ and connection status are indicated by a Boolean expression with three numbers representing in order from left to right the state of the input signals S2i and S1i, and connection status. Each number can have the value of 1 or 0 depending on the corresponding state of the parameter. States of the output signals S₂ₒ and S₁ₒ are shown as a Boolean expression in the state circles 00, 01, 10 and 11.

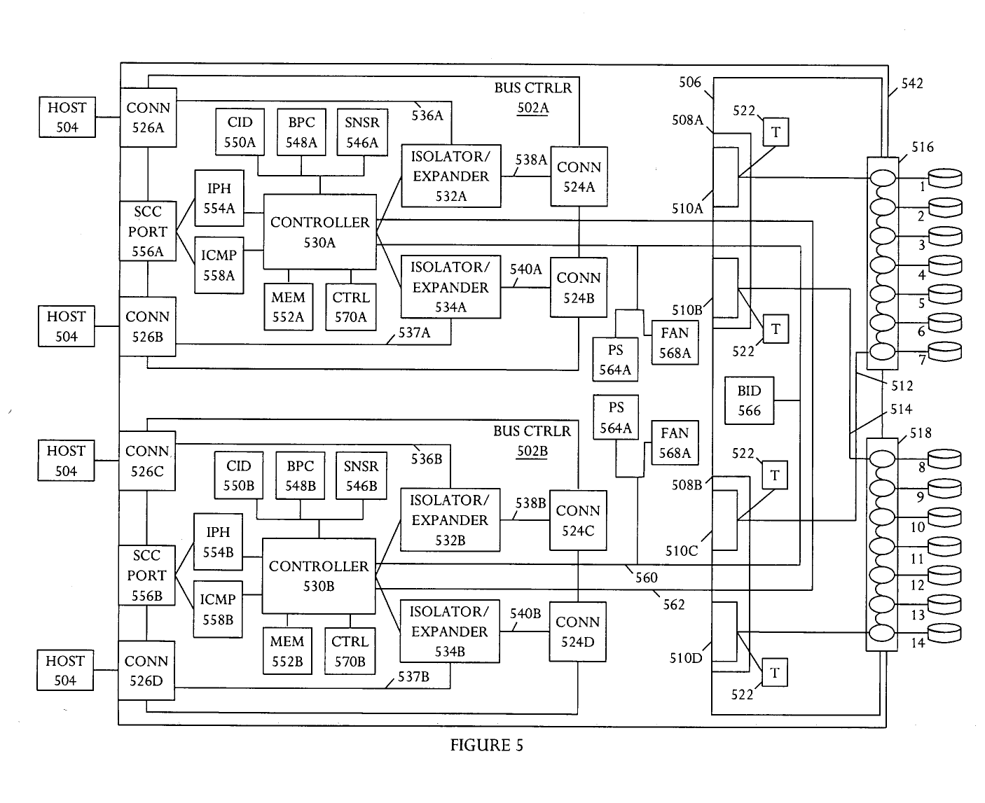

FIG. 5 is a block diagram showing a data communication system 500 for high speed data transfer between peripheral devices 1 through 14 and host computers 504 via BCCs 502A and 502B. Bus controller cards (BCCs) 502A and 502B are configured to transfer data at very high speeds, such as 160, 320, or more, megabytes per second. One BCC 502A or 502B can assume data transfer responsibilities of the other BCC when the other BCC is removed or is disabled by a fault/error condition. BCCs 502A and 502B include monitoring circuitry to detect events such as removal or insertion of the other BCC, and monitor operating status of the other BCC. When a BCC is inserted but has a fault condition, the other BCC can reset the faulted BCC. Under various situations BCCs 502A, 502B can include one or more other logic components that hold the reset signal and prevent lost or corrupted data transfers until system components are configured and ready for operation.

BCCs 502A and 502B interface with backplane 506, typically a printed circuit board (PCB) that is installed within other assemblies such as a chassis for housing peripheral devices 1 through 14, as well as BCCs 502A, 502B. In some embodiments, backplane 506 includes interface slots 508A, 508B with connector portions 510A, 510B, and 510C, 510D, respectively, that electrically connect BCCs 502A and 502B to backplane 506.

Interface slots 508A and 508B, also called bus controller slots 508A and 508B, are electrically connected and configured to interact and communicate with components included on BCCs 502A, 502B and backplane components. Generally, when multiple peripheral devices and controller cards are included in a system, various actions or events can affect system configuration. Controllers 530A and 530B can include logic that configures status of BCCs 502A and 502B depending on the type of action or event. The actions or events can include: attaching or removing one or more peripheral devices from system 500; attaching or removing one or more controller cards from system 500; removing or attaching a cable to backplane 506; and powering system 500.

BCCs 502A and 502B can be fabricated as single or multi-layered printed circuit board(s), with layers designed to accommodate specified impedance for connections to host computers 504 and backplane 506. In some embodiments, BCCs 502A and 502B handle only differential signals, such as LVD signals, eliminating support for single ended (SE) signals and simplifying impedance matching considerations. Some embodiments allow data path signal traces on either internal layers or the external layers of the PCB, but not both, to avoid speed differences in the data signals. Data signal trace width on the BCC PCBs can be varied to match impedance at host connector portions 526A through 526D, and at backplane connector portions 524A through 524D.

Buses A 512 and B 514 on backplane 506 enable data communication between peripheral devices 1 through 14 and host computing systems 504, functionally coupled to backplane 506 via BCCs 502A, 502B. BCCs 502A and 502B, as well as A and B buses 512 and 514, can communicate using the SCSI communication or other protocol. In some embodiments, buses 512 and 514 are low voltage differential (LVD) Ultra-4 or Ultra-320 SCSI buses, for example. Alternatively, system 500 may include other types of communication interfaces and operate in accordance with other communication protocols.

A bus 512 and B bus 514 include a plurality of ports 516 and 518 respectively. Ports 516 and 518 can each have the same physical configuration. Peripheral devices 1 through 14 such as disk drives or other devices are adapted to communicate with ports 516, 518. Arrangement, type, and number of ports 516, 518 between buses 512, 514 may be configured in other arrangements and are not limited to the embodiment illustrated in FIG. 5.

In some embodiments, connector portions 510A and 510C are electrically connected to A bus 512, and connector portions 510B and 510D are electrically connected to B bus 514. Connector portions 510A and 510B are physically and electrically configured to receive a first bus controller card, such as BCC 502A. Connector portions 510C and 510D are physically and electrically configured to receive a second bus controller card such as BCC 502B.

BCCs 502A and 502B respectively include transceivers that can convert voltage levels of differential signals to the voltage level of signals utilized on a single-ended bus, or can only recondition and resend the same signal levels. Terminators 522 can be connected to backplane connectors 510A through 510D to signal the terminal end of buses 512, 514. To work properly, terminators 522 use “term power” from bus 512 or 514. Term power is typically supplied by the host adapter and by the other devices on bus 512 and/or 514 or, in this case, power is supplied by a local power supply. In one embodiment, terminators 522 can be model number DS2108 terminators from Dallas Semiconductor.

In one or more embodiments, BCCs 502A, 502B include connector portions 524A through 524D, which are physically and electrically adapted to mate with backplane connector portions 510A through 510D. Backplane connector portions 510A through 510D and connector portions 524A through 524D are most appropriately impedance controlled connectors designed for high-speed digital signals. In one embodiment, connector portions 524A through 524D are 120 pin count Methode/Teradyne connectors.

In some embodiments, one of BCC 502A or 502B assumes primary status and acts as a central control logic unit for managing configuration of system components. With two or more BCCs, system 500 can be implemented to give primary status to a BCC in a predesignated slot. The primary and non-primary BCCs are substantially physically and electrically the same, with “primary” and “non-primary” denoting functions of the bus controller cards rather than unique physical configurations. Other schemes for designating primary and non-primary BCCs can be utilized.

In some embodiments, the primary BCC is responsible for configuring buses 512, 514, as well as performing other services such as bus addressing. The non-primary BCC is not responsible for configuring buses 512, 514, and responds to bus operation commands from the primary card rather than initiating commands independently. In other embodiments, both primary and non-primary BCCs can configure buses 512, 514, initiate, and respond to bus operation commands.

BCCs 502A and 502B can be hot-swapped, the ability to remove and replace BCC 502A and/or 502B without interrupting communication system operations. The interface architecture of communication system 500 allows BCC 502A to monitor the status of BCC 502B, and vice versa. In some circumstances, such as hot-swapping, BCCs 502A and/or 502B perform fail-over activities for robust system performance. For example, when BCC 502A or 502B is removed or replaced, is not fully connected, or experiences a fault condition, the other BCC performs functions such as determining whether to change primary or non-primary status, setting signals to activate fault indications, and resetting BCC 502A or 502B. For systems with more than two BCCs, the number and interconnections between buses on backplane 506 can vary accordingly.

Host connector portions 526A, 526B are electrically connected to BCC 502A. Similarly, host connector portions 526C, 526D are electrically connected to BCC 502B. Host connector portions 526A through 526D are adapted, respectively, for connection to a host device, such as a host computers 504. Host connector portions 526A through 526D receive voltage-differential input signals and transmit voltage-differential output signals. BCCs 502A and 502B can form an independent channel of communication between each host computer 504 and communication buses 512, 514 implemented on backplane 506. In some embodiments, host connector portions 526A through 526D are implemented with connector portions that conform to the Very High Density Cable Interconnect (VHDCI) connector standard. Other suitable connectors and connector standards can be used.

Card controllers 530A, 530B can be implemented with any suitable processing device, such as controller model number VSC205 from Vitesse Semiconductor Corporation in Camarillo, Calif. in combination with FPGA/PLDs that are used to monitor and react to time sensitive signals. Card controllers 530A, 530B execute instructions to control BCC 502A, 502B; communicate status information and data to host computers 504 via a data bus, such as a SCSI bus; and can also support diagnostic procedures for various components of system 500.

BCCs 502A and 502B can include isolators/expanders 532A, 534A, and 532B, 534B, respectively, to isolate and retime data signals. Isolators/expanders 532A, 534A can isolate A and B buses 512 and 514 from monitor circuitry on BCC 502A, while isolators/expanders 532B, 534B can isolate A and B buses 512 and 514 from monitor circuitry on BCC 502B. Expander 532A communicates with backplane connector 524A, host connector portion 526A, and card controller 530A, while expander 534A communicates with backplane connector 524B, host connector portion 526B and card controller 530A. On BCC 502B, expander 532B communicates with backplane connector 524C, host connector portion 526B, and controller 530B, while expander 534B communicates with backplane connector 524D, host connector portion 526D and controller 530B.

Expanders 532A, 534A, 532B, and 534B support installation, removal, or exchange of peripherals while the system remains in operation. A controller or monitor that performs an isolation function monitors and protects host computers 504 and other devices by delaying the actual power up/down of the peripherals until an inactive time period is detected between bus cycles, preventing interruption of other bus activity. The isolation function also prevents power sequencing from generating signal noise that can corrupt data signals. In some embodiments, expanders 532A, 534A, and 532B, 534B are implemented in an integrated circuit from LSI Logic Corporation in Milpitas, Calif., such as part numbers SYM53C180 or SYM53C320, depending on the data transfer speed. Other suitable devices can be utilized. Expanders 532A, 534A, and 532B, 534B can be placed as close to backplane connector portions 524A through 524D as possible to minimize the length of data bus signal traces 538A, 540A, 538B, and 540B.

Impedance for the front end data path from host connector portions 526A and 526B to card controller 530A is designed to match a cable interface having a measurable coupled differential impedance, for example, of 135 ohms. Impedance for a back end data path from expanders 532A and 534A to backplane connector portions 524A and 524B typically differs from the front end data path impedance, and may only match a single-ended impedance, for example 67 ohms, for a decoupled differential impedance of 134 ohms.

In the illustrative embodiment, buses 512 and 514 are each divided into three segments on BCCs 502A and 502B, respectively. A first bus segment 536A is routed from host connector portion 526A to expander 532A to card controller 530A, to expander 534A, and then to host connector portion 526B. A second bus segment 538A originates from expander 532A to backplane connector portion 524A, and a third bus segment 540A originates from expander 534A to backplane connector portion 524B. BCC 502A can connect to buses 512, 514 on backplane 506 if both isolators/expanders 532A and 534A are activated, or connect to one bus on backplane 506 if only one expander 532A or 534A is activated. A similar data bus structure can be implemented on other BCCs, such as BCC 502B, shown with bus segments 536B, 538B, and 540B corresponding to bus segments 536A, 538A, and 540A on BCC 502A. BCCs 502A and 502B respectively can include transceivers to convert differential signal voltage levels to the voltage level of signals on buses 536A and 536B.

System 500 can operate in full bus or split bus mode. In full bus mode, all peripherals 1-14 can be accessed by the primary BCC and the Secondary BCC, if available. The non-primary BCC assumes Primary functionality in the event of Primary failure. In split bus mode, one BCC accesses data through A bus 512 while the other BCC accesses peripherals 1-14 through B bus 514. In some embodiments, a high and low address bank for each separate bus 516, 518 on backplane 506 can be utilized. In other embodiments, each slot 508A, 508B on backplane 506 is assigned an address to eliminate the need to route address control signals across backplane 506. In split bus mode, monitor circuitry utilizes an address on backplane 506 that is not utilized by any of peripherals 1 through 14. For example, SCSI bus typically allows addressing up to 15 peripheral devices. One of the 15 addresses can be reserved for use by the monitor circuitry on BCCs 502A, 502B to communicate operational and status parameters to Hosts 504. BCCs 502A and 502B communicate with each other over out of band serial buses such as general purpose serial I/O bus

For BCCs 502A and 502B connected to backplane 506, system 500 operates in full bus mode with the separate buses 512, 514 interconnected on backplane 506. The non-primary BCC does not receive commands directly from bus 512 or 514 since primary BCC sends bus commands to the non-primary BCC. Other addressing and command schemes may be suitable. Various configurations of host computers 504 and BCCs 502A, 502B can be included in system 500, such as:

two host computers 504 connected to a single BCC in full bus mode;

two BCCs in full or split bus mode and two host computers 504, with one of host computer 504 connected to one BCC, and the other host computer 504 connected to the other BCC; and

two BCCs in full or split bus mode and four host computers 504, as shown in FIG. 5.

In some examples, backplane 506 may be included in a Hewlett-Packard DS2300 disk enclosure and may be adapted to receive DS2300 bus controller cards. DS2300 controller cards use a low voltage differential (LVD) interface to buses 512 and 514.

System 500 has components for monitoring enclosure 542 and operating BCCs 502A and 502B. The system 500 includes card controllers 530A, 530B; sensors modules 546A, 546B; backplane controllers (BPCs) 548A, 548B; card identifier modules 550A, 550B; and backplane identifier module 566. The system 500 also includes flash memory 552A, 552B; serial communication connector port 556A, 556B, such as an RJ12 connector port; and interface protocol handlers such as RS-232 serial communication protocol handler 554A, 554B, and Internet Control Message Protocol handler 558A, 558B. The system monitors status and configuration of enclosure 542 and BCCs 502A, 502B; gives status information to card controllers 530A, 530B and to host computers 504; and controls configuration and status indicators. In some embodiments, monitor circuitry components on BCCs 502A, 502B communicate with card controllers 530A, 530B via a relatively low-speed system bus, such as an Inter-IC bus (I2C). Other data communication infrastructures and protocols may be suitable.

Status information can be formatted using standardized data structures, such as SCSI Enclosure Services (SES) and SCSI Accessed Fault Tolerant Enclosure (SAF-TE) data structures. Messaging from enclosures that are compliant with SES and SAF-TE standards can be translated to audible and visible notifications on enclosure 542, such as status lights and alarms, to indicate failure of critical components. Enclosure 542 can have one or more switches, allowing an administrator to enable the SES, SAF-TE, or other monitor interface scheme.

Sensor modules 546A, 546B can monitor voltage, fan speed, temperature, and other parameters at BCCs 502A and 502B. One suitable set of sensor modules 546A, 546B is model number LM80, which is commercially available from National Semiconductor Corporation in Santa Clara, Calif. In some embodiments, Intelligent Platform Management Interface (IPMI) specification defines a standard interface protocol for sensor modules 546A and 546B. Other sensors specifications may be suitable.

Backplane controllers 548A, 548B interface with card controllers 530A, 530B, respectively, to give control information and report on system configuration. In some embodiments, backplane controllers 548A, 548B are implemented with backplane controller model number VSC055 from Vitesse Semiconductor Corporation in Camarillo, Calif. Other components for performing backplane controller functions may be suitable. Signals accessed by backplane controllers 548A, 548B can include disk drive detection, BCC primary or non-primary status, expander enable and disable, disk drive fault indicators, audible and visual enclosure or chassis indicators, and bus controller card fault detection. Other signals include bus reset control enable, power supply fan status, and others.

Card identifier modules 550A, 550B supply information, such as serial and product numbers of BCCs 502A and 502B to card controllers 530A, 530B. Backplane identifier module 566 also supplies backplane information such as serial and product number to card controllers 530A, 530B. In some embodiments, identifier modules 550A, 550B, and 566 are implemented with an electronically erasable programmable read only memory (EEPROM) and conform to Field Replaceable Unit Identifier (FRU-ID) standard. Field replaceable units (FRU) can be hot swappable and individually replaced by a field engineer. A FRU-Id code can be included in an error message or diagnostic output indicating the physical location of a system component such as a power supply or I/O port. Other identifier modules may be suitable.

RJ-12 connector 556A enables connection to a diagnostic port in card controller 530A, 530B to access troubleshooting information, download software and firmware instructions, and as an ICMP interface for test functions.

Monitor data buses 560 and 562 transmit data between card controllers 530A and 530B across backplane 506. Data exchanged between controllers 530A and 530B can include a periodic heartbeat signal from each controller 530A, 530B to the other to indicate the other is operational, a reset signal allowing reset of a faulted BCC by another BCC, and other data. If the heartbeat signal is lost in the primary BCC, the non-primary BCC assumes primary BCC functions. Operational status of power supply 564A and a cooling fan can also be transmitted periodically to controller 530A via bus 560. Similarly, bus 560 can transmit operational status of power supply 564B and the cooling fan to controller 530B. Card controllers 530A and 530B can share data that warns of monitoring degradation and potential failure of a component. Warnings and alerts can be issued by any suitable method such as indicator lights on enclosure 542, audible tones, and messages displayed on a system administrator's console. In some embodiments, buses 560 and 562 can be implemented with a relatively low-speed system bus, such as an Inter-IC bus (I2C). Other suitable data communication infrastructures and protocols can be utilized in addition to, or instead of, the I2C standard.

Panel switches and internal switches may be also included on enclosure 542 for BCCs 502A and 502B. The switches can be set in various configurations, such as split bus or full bus mode, to enable desired system functionality.

One or more logic units can be included on BCCs 502A and 502B, such as FPGA 554A, to perform time critical tasks. For example, FPGA 554A can generate reset signals and control enclosure indicators to inform of alert conditions and trigger processes to help prevent data loss or corruption. Conditions may include insertion or removal of a BCC in system 500; insertion or removal of a peripheral; imminent loss of power from power supply 564A or 564B; loss of term power; and cable removal from one of host connector portions 526A through 526D.

Instructions in FPGAs 554A, 554B can be updated by corresponding card controller 530A, 530B or other suitable devices. Card controllers 530A, 530B and FPGAs 554A, 554B can cross-monitor operating status and assert a fault indication on detection of non-operational status. In some embodiments, FPGAs 554A, 554B include instructions to perform one or more of functions including bus resets, miscellaneous status and control, and driving indicators. Bus resets may include reset on time critical conditions such as peripheral insertion and removal, second BCC insertion and removal, imminent loss of power, loss of termination power, and cable or terminator removal from a connector. Miscellaneous status and control includes time critical events such as expander reset generation and an indication of BCC full insertion. Non-time critical status and control includes driving the disks delayed start signal and monitoring BCC system clock and indicating clock failure with a board fault. Driving indicators include a peripheral fault indicator, a bus configuration (full or split bus) indicator, a term power available indicator, an SES indicator for monitoring the enclosure, SAF-TE indicator for enclosure monitoring, an enclosure power indicator, and an enclosure fault or FRU failure indicator.

A clock signal can be supplied by one or more of host computers 504 or generated by an oscillator implemented on BCCs 502A and 502B. The clock signal can be supplied to any component on BCCs 502A and 502B.

The illustrative BCCs 502A and 502B enhance BCC functionality by enabling high speed signal communication across separate buses 512, 514 on backplane 506. Alternatively, high speed signals from host connector portions 526A and 526B, or 526C and 526D, can be communicated across only one of buses 512, 514.

High speed data signal integrity can be optimized in illustrative BCC embodiments by matching impedance and length of the traces for data bus segments 536A, 538A, and 540A across one or more PCB routing layers. Trace width can be varied to match impedance and trace length varied to match electrical lengths, improving data transfer speed. Signal trace stubs to components on BCC 502A can be reduced or eliminated by connecting signal traces directly to components rather than by tee connections. Length of bus segments 538A and 540A can be reduced by positioning expanders 532A and 534A as close to backplane connector portions 524A and 524B as possible.

In some embodiments, two expanders 532A, 534A on the same BCC 502A can be enabled simultaneously, forming a controllable bridge connection between A bus 512 and B bus 514, eliminating the need for a dedicated bridge module.

Described logic modules and circuitry may be implemented using any suitable combination of hardware, software, and/or firmware, such as Field Programmable Gate Arrays (FPGAs), Application Specific Integrated Circuit (ASICs), or other suitable devices. A FPGA is a programmable logic device (PLD) with a high density of gates. An ASIC is a microprocessor that is custom designed for a specific application rather than a general-purpose microprocessor. Use of FPGAs and ASICs improves system performance in comparison to general-purpose CPUs, because logic chips are hardwired to perform a specific task and avoid the overhead of fetching and interpreting stored instructions. Logic modules can be independently implemented or included in one of the other system components such as controllers 530A and 530B. Other BCC components described as separate and discrete components may be combined to form larger or different integrated circuits or electrical assemblies, if desired.

Although the illustrative example describes a particular type of bus interface, specifically a High Speed Dual Ported SCSI Bus Interface, the claimed elements and actions may be utilized in other bus interface applications defined under other standards. Furthermore, the particular control and monitoring devices and components may be replaced by other elements that are capable of performing the illustrative functions. For example, alternative types of controllers may include processors, digital signal processors, state machines, field programmable gate arrays, programmable logic devices, discrete circuitry, and the like. Program elements may be supplied by various software, firmware, and hardware implementations, supplied by various suitable media including physical and virtual media, such as magnetic media, transmitted signals, and the like.

What is claimed is:

1. A monitor for a dual ported bus interface comprising:
a controller coupled to the dual ported bus interface, the dual ported bus interface having first and second front end ports capable of connecting to host bus adapters, first and second backplane connectors for coupling to one or more buses on the backplane, and interconnections for coupling signals from the first and second front end ports through to the backplane buses; and
a programmable code executable on the controller and further comprising:
a programmable code that monitors term power, a differential sense signal, and connectivity states for the first and second front end ports; and
a programmable code that identifies port state based on the monitored term power, a differential sense signal, and connectivity states.

2. The monitor according to claim 1 further comprising:
a programmable code executable on the controller that identifies a front end port state from among Not Connected, Connected, Improperly Connected, and Faulted states.

3. The monitor according to claim 1 further comprising:
a programmable code executable on the controller that identifies a Connected state for conditions of term power at a voltage between 3.0 volts and 5.25 volts, a differential sense signal at a voltage level between 0.7 volts and 1.9 volts to indicate low voltage differential connections, and at least one port of the first and second front end ports connected to a host bus adapter that supplies the termination, the term power, and the differential sense signal.

4. The monitor according to claim 1 further comprising:
a programmable code executable on the controller that determines term power is available at a voltage range between 3.0 volts and 5.25 volts and otherwise is not available.

5. The monitor according to claim 1 further comprising:
a programmable code executable on the controller that determines a differential sense signal is available at a voltage level in a range between 0.7 volts and 1.9 volts to indicate low voltage differential connections, and otherwise is not available.

6. The monitor according to claim 1 further comprising:
a programmable code executable on the controller that identifies a Connected state when term power is available, the differential sense signal is available, one port of the first and second front end ports connected to a first host bus adapter that supplies the termination, the term power, and the differential sense signal, and the other port of the first and second front end ports is alternatively coupled to a second host bus adapter or a terminator.

7. The monitor according to claim 1 further comprising:
a port connection controller that monitors the first and second front end port connections by isolating at least two ground pins, pulling the isolated ground pins high, and monitoring the ground pins to determine whether a connection pulls the ground pins low.

8. The monitor according to claim 1 further comprising:
a programmable code executable on the controller that identifies a Not Connected state for conditions:
term power is not available and the first and second front end ports are connected; or
both first and second front end port are unconnected.

9. The monitor according to claim 1 further comprising:
a programmable code executable on the controller that identifies an Improper Connection state for conditions:
only one of the first and second front end ports is connected; or
both the first and second front end ports are connected, term power is available, and the differential sense signal is not available.

10. The monitor according to claim 1 further comprising:
a programmable code executable on the controller that identifies a Fault state for the condition:
term power is available and both the first and second front end ports are not connected.

11. A dual ported bus interface comprising:
first and second front end ports capable of connecting to host bus adapters;
first and second backplane connectors for coupling to one or more buses on the backplane;
interconnections including a bridge connection for coupling signals from the first and second front end ports through to the backplane buses;
a monitor that monitors term power, a differential sense signal, and connectivity states for the first and second front end ports; and
a controller that identifies port state based on the monitored term power, a differential sense signal, and connectivity states.

12. The bus interface according to claim 11 wherein:
the controller identifies a front end port state from among Not Connected, Connected, Improperly Connected, and Faulted states.

13. The bus interface according to claim 11 wherein:
the monitor determines term power is available at a voltage range between 3.0 volts and 5.25 volts and otherwise is not available, and determines a differential sense signal is available at a voltage level in a range between 0.7 volts and 1.9 volts to indicate low voltage differential connections, and otherwise is not available.

14. The bus interface according to claim 11 wherein:
the controller identifies a Connected state when term power is available, the differential sense signal is available, one port of the first and second front end ports connected to a first host bus adapter that supplies the termination, the term power, and the differential sense signal, and the other port of the first and second front end ports is alternatively coupled to a second host bus adapter or a terminator.

15. The bus interface according to claim 11 wherein:
the monitor monitors the first and second front end port connections by isolating at least two ground pins, pulling the isolated ground pins high, and monitoring the ground pins to determine whether a connection pulls the ground pins low.

16. The bus interface according to claim 11 wherein:
the controller identifies a Not Connected state for conditions:
term power is not available and the first and second front end ports are connected; or
both first and second front end port are unconnected.

17. The bus interface according to claim 11 wherein:
the controller identifies an Improper Connection state for conditions:
only one of the first and second front end ports is connected; or
both the first and second front end ports are connected, term power is available, and the differential sense signal is not available.

18. The bus interface according to claim 11 wherein:
the controller identifies a Fault state for the condition:
term power is available and both the first and second front end ports are not connected.

19. A method of identifying port state for a dual ported bus interface comprising:
connecting to first and second front end ports of the dual ported bus interface;
monitoring term power, a differential sense signal, and connectivity states for the first and second front end ports; and
identifying port state based on the monitored term power, a differential sense signal, and connectivity states.

20. The method according to claim 19 further comprising:
identifying a front end port state from among Not Connected, Connected, Improperly Connected, and Faulted states.

21. The method according to claim 19 further comprising:
determining term power is available at a voltage range between 3.0 volts and 5.25 volts and otherwise is not available; and
determining a differential sense signal is available at a voltage level in a range between 0.7 volts and 1.9 volts to indicate low voltage differential connections, and otherwise is not available.

22. The method according to claim 19 further comprising:
identifying a Connected state when term power is available, the differential sense signal is available, one port of the first and second front end ports connected to a first host bus adapter that supplies the termination, the term power, and the differential sense signal, and the other port of the first and second front end ports is alternatively coupled to a second host bus adapter or a terminator.

23. The method according to claim 19 further comprising:
monitoring the first and second front end port connections further comprising:
isolating at least two ground pins;
pulling the isolated ground pins high; and
monitoring the ground pins to determine whether a connection pulls the ground pins low.

24. The method according to claim 19 further comprising:
identifying a Not Connected state for conditions:
term power is not available and the first and second front end ports are connected; or
both first and second front end port are unconnected.

25. The method according to claim 19 further comprising:
identifying an Improper Connection state for conditions:
only one of the first and second front end ports is connected; or
both the first and second front end ports are connected, term power is available, and the differential sense signal is not available.

26. The method according to claim 19 further comprising:
identifying a Fault state for the condition:
term power is available and both the first and second front end ports are not connected.

27. A dual ported bus interface comprising:
means for connecting to host bus adapters;
means coupled to the connecting means for coupling to one or more buses on the backplane;
means for interconnecting signals from the first and second front end ports through to the backplane buses, the signal interconnecting means further comprising means for bridging between the first and second isolator/expanders;
means for monitoring term power, a differential sense signal, and connectivity states for the first and second front end ports; and
means for identifying port state based on the monitored term power, a differential sense signal, and connectivity states.
